(19) United States
(12) Patent Application Publication
(10) Pub. No.: US 2002/0194830 A1
(43) Pub. Date: Dec. 26, 2002

(54) Reversible spindle for lawnmower

(76) Inventors: Jimmy N. Eavenson SR., Aurora, OH (US); Gary Hobrath, Brunswick, OH (US); Jim Cykon, Warren, OH (US)

Correspondence Address: Roger D. Emerson, One Cascade Plaza, 14th Floor, Akron, OH, 44308-1381, US

(21) Appl. No.: 09/887,506

(22) Filed: Jun. 22, 2001

(51) Int. Cl. A01D 67/00

(52) U.S. Cl. 56/320.1

(57) ABSTRACT

There is provided a mower having a mower deck wherein is received a spindle. The spindle includes a body and a shaft that longitudinally extends beyond the body. The shaft is adapted to receive a cutting blade at either end of the shaft. The shaft is also adapted to receive a pulley at either end of the shaft, wherein the pulley is opposite the cutting blade. The spindle further includes two shields, each received by an opposite end of the shaft. In this manner, the spindle is adapted to be invertibly mounted between first and second positions to multiple mower decks having different cutting height requirements. The body also includes a flange portion having a plurality of sets of mounting holes fashioned therein. The sets of mounting holes are disposed at different radii about the flange for mounting the spindle into different mower decks having different mounting hole patterns.

### I. BACKGROUND OF THE INVENTION

A. Field of the Invention

This invention relates to the art of spindles and, more specifically, to reversible spindles, especially as related to spindles used on mower decks for vegetation mowers.

B. Description of the Related Art

Mower decks incorporate spindles that, at one end, receive power from the mower engine, wherein power is typically transferred by way of a pulley and belt system. At the opposing end, the spindles are adapted to receive a cutting blade. Generally, a spindle is chosen to match to the mower deck onto which it is installed. For example, the bolt pattern of the spindle is matched to the mower deck, as well as, the length of the spindle, which predetermines the cutting height relative to the mower deck.

U.S. Pat. No. 4,989,398 to Kuhn et al discloses a belt driven mower spindle and sheave assembly having a plurality of bushings and bearings compressed with the sheave on the spindle between a nut and a support portion of the spindle. The patent further discloses that the invention incorporates a shoulder portion integrally formed on the lower portion of the spindle. A sheave is disclosed mounted at the opposite end, which receives a pulley belt.

One aspect of mower deck spindles is that they are intended for use on a particular mower deck. The bolt pattern, generally fashioned within a flange portion of the spindle, predetermines the mower deck onto which it may be installed. Likewise, the length of the spindle, below the flange portion, predetermines the cutting blade height within the mower deck, as that portion extends into the region of the mower deck housing. A mower deck is consequently matched to a specific spindle.

It would advantageous to adapt a spindle that could be used on a plurality of mower decks. Such a spindle would reduce manufacturing costs by allowing manufacturers to stock fewer types of spindles. The following invention discloses an apparatus and method for solving the aforementioned problems.

### II. SUMMARY OF THE INVENTION

It is the object of the present invention to provide a spindle that could be inverted for use on a plurality of mower decks.

It is another object of the invention to provide a spindle including a plurality of mounting bolt patterns.

It is still another object of the present invention to provide shaft shields received at both ends of the spindle.

According to the present invention, there is provided a mower having a mower deck wherein is received a spindle. The spindle includes a body and a shaft that longitudinally extends beyond the body. The shaft is adapted to receive a cutting blade at either end of the shaft. The shaft is also adapted to receive a pulley at either end of the shaft, wherein the pulley is opposite the cutting blade. The spindle further includes two shields, each received by an opposite end of the shaft. In this manner, the spindle is adapted to be invertibly mounted between first and second positions to multiple mower decks having different cutting height requirements. The body also includes a flange portion having a plurality of sets of mounting holes fashioned therein. The sets of mounting holes are disposed at different radii about the flange for mounting the spindle into different mower decks having different mounting hole patterns.

Other objects and advantages of the invention will appear from the following detailed description of the preferred embodiment of the invention, with reference being made to the accompanying drawings.

### III. BRIEF DESCRIPTION OF DRAWINGS

The invention may take physical form in certain parts and arrangement of parts, a preferred embodiment of which will be described in detail in this specification and illustrated in the accompanying drawings, which form a part hereof and wherein:

FIG. 1 is a perspective view of a vegetation mower.

FIG. 2 is a cutaway perspective view of the mower deck spindle

FIG. 3 is an end view of the mower deck spindle.

FIG. 4 is a partial side view of the spindle attached to the mower deck in a first position.

FIG. 4a is a partial side view of the spindle attached to the mower deck in a second position.

### IV. DETAILED DESCRIPTION OF THE INVENTION

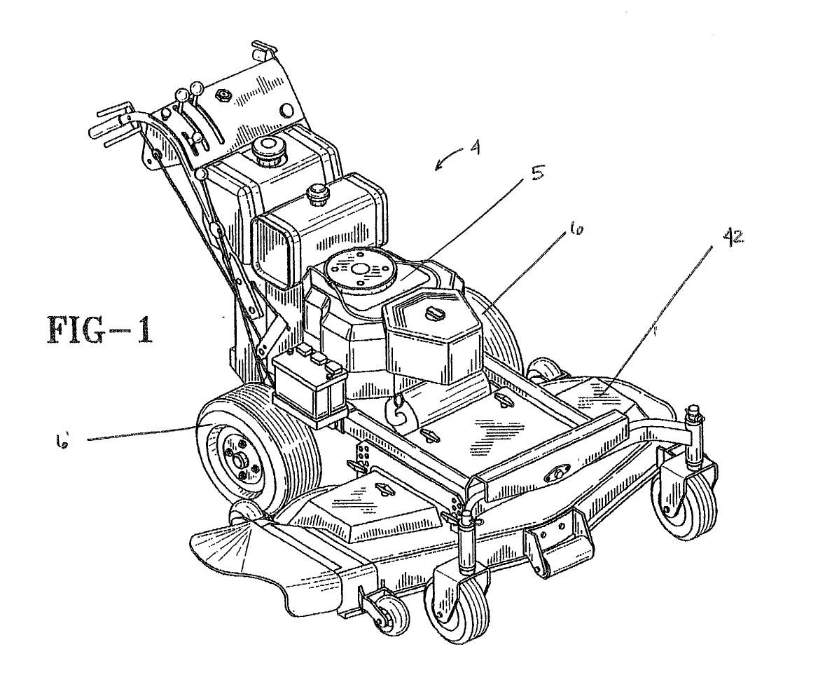

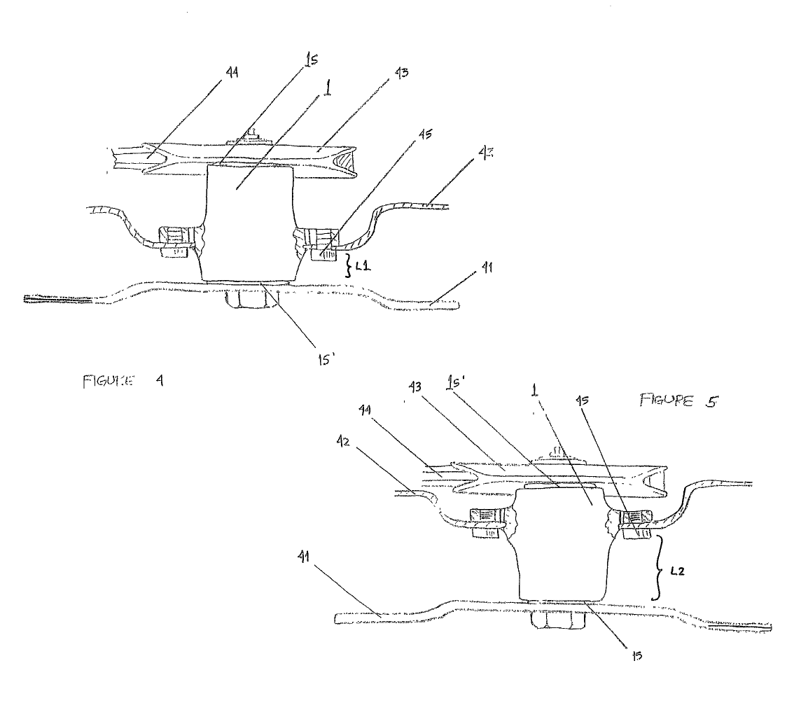

Referring now to the drawings wherein the showings are for purposes of illustrating a preferred embodiment of the invention and not for purposes of limiting the same, FIG. 1 shows a vegetation mower 4 having a mower deck 42, an engine 5 and rear ground engaging wheels 6, 6′. The mower deck 42 includes at least a first spindle 1 that is operatively communicated at one end to a power-transferring device, which in one embodiment may include a pulley 43 and belt 44, shown in FIG. 4, 4a. However, any means of transferring power may be chosen with sound engineering judgment. The belt 44 communicates rotational power from the engine 5 to the spindle 1. It is expressly stated that the present invention described herein is applicable to any vegetation or turf maintenance implement requiring a spindle.

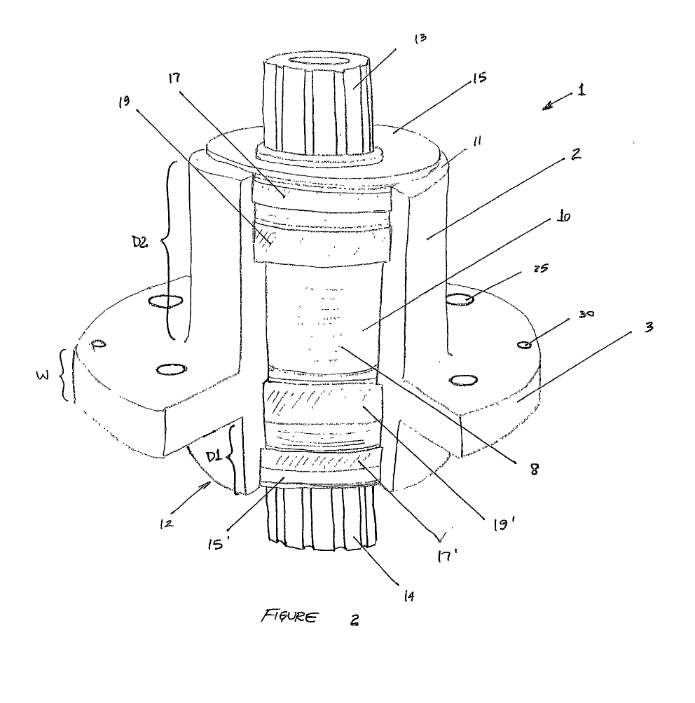

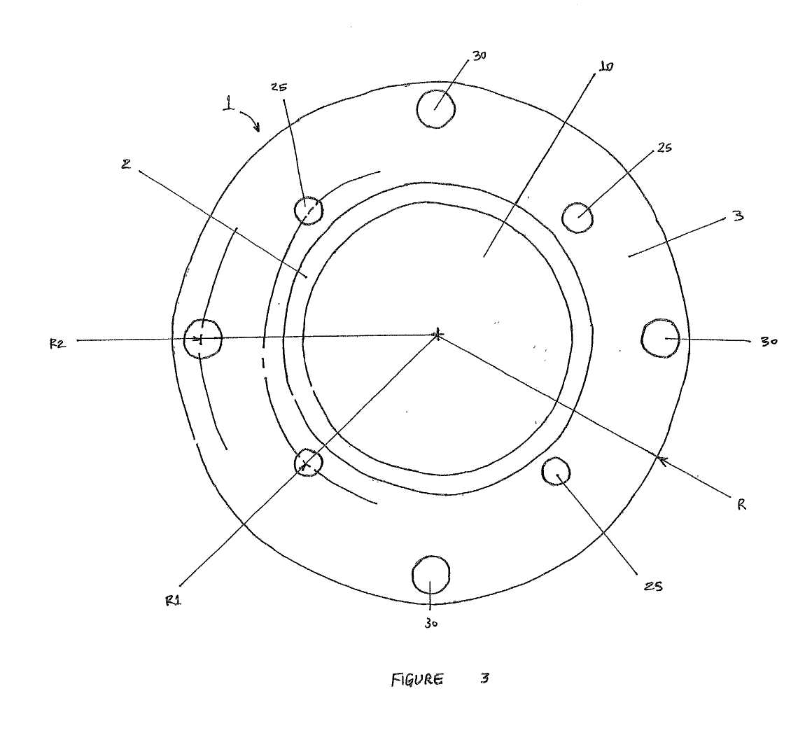

Referring now to FIG. 2, a spindle, shown generally at 1, includes a body portion 2 and a flange portion 3. The body portion 2 is generally tubular having an overall length L and an outer surface from which radially extends a flange portion 3. The flange portion 3 may have any shape chosen with sound engineering judgment, although in one embodiment the flange portion 3 is disk shaped. The flange portion 3 also has a characteristic width W and radius R, shown in FIG. 3 that may be chosen with sound engineering judgment. An inner region 10 of the body portion 2 receives bearings 19, 19′, seals 17, 17′ and a spindle shaft 8. In that the internal makeup of spindles are well known in the art, no further explanation will be offered here. The ends 13, 14 of the spindle shaft 8 extends longitudinally from both ends 11, 12 of the body portion 2, respectively. Each of the respective ends 13, 14 of the spindle shaft 8 is adapted to receive a cutting blade 41 or a pulley 43, as shown in FIG. 4. In one embodiment, the ends 13, 14 of the spindle shaft 8 are splined to correspond to a splined pulley 43 and cutting blade 41. However, any means of attaching the blade 41 and pulley 43 to the ends 13, 14 of the spindle shaft 8 may be chosen with sound engineering judgment. Shields 15, 15′ are received by each of the respective ends 13, 14 of the spindle shaft 8. The shields 15, 15′ are longitudinally juxtaposed to the ends 11, 12 of the body portion 2. In this manner, the shields 15, 15′ are disposed between the ends 11, 12 of the body portion 2 and the pulley 43 and cutting blade 41, respectively.

Still referring to FIG. 2, the flange portion 3 is fashioned as longitudinally extending from the outer surface of the body portion 2 at distance D2 from one end 11 of the body portion 2 and at a distance D1 from the other end 12 of the body portion 2, wherein the distance D2 is greater than the distance D1. In one embodiment, the distance D2 is 3 times the distance D1. However, any ratio of D1/D2 may be chosen with sound engineering judgment.

Referring now to FIG. 3, first and second sets of holes 25, 30 are fashioned at distinct points along a path having a radius R1 and R2 respectively. In one embodiment, the radius R1 is one half of the radius R2. However, any length of R1 or R2 may be chosen with sound engineering judgment as is appropriate for mounting a spindle to a mower deck. Additionally, in one embodiment, the number of holes contained in a single set 25, 30 may be four. However, any number of holes may be fashioned therein as chosen with sound engineering judgment. Finally, the diameter of the holes in each set may be chosen with sound engineering judgment, as is appropriate for attaching the spindle 1 to a mower deck 42. The holes of the sets 25, 30 receive fasteners, shown generally at 45 in FIG. 4 and 4a, that rigidly secure the spindle 1 to the mower deck 42. In one embodiment, the holes of the sets 25, 30 may be threaded to match the threads of the fasteners 45.

Referring now to FIG. 4 and 4a, mounting of the present invention will now be discussed. According to the aforementioned description, the spindle 1 may be installed in a first position mounted to a first mower deck 42, as shown in FIG. 4 via fasteners 45 operatively engaging one set of holes 30, and subsequently the mower deck 42. In this position, the distance LI of the cutting blade 41 with respect to the mower deck 42 is a minimum. The spindle 11 may also be installed in a second position via fasteners 45 engaging holes 30 and the mower deck 42, as shown in FIG. 4a, wherein the distance L2 of the cutting blade 41 with respect to the mower deck 42 is a maximum. In this manner, the spindle 1 is reversible in that spindle 1 can be invertibly mounted between the first and second positions to change the cutting blade height with respect to the mower deck 42. The spindle 1 may be mounted in the second position to a second mower deck, not shown.

With reference to FIG. 4, 4a and 3, the spindle 1 may also be mounted in the first position to a third mower deck, not shown, via an alternate set of fasteners, not shown, operatively engaging a second set of holes 25, and subsequently the mower deck. Additionally, spindle 1 may be invertibly mounted in the second position to a fourth mower deck, not shown, via alternate fasteners, engaging holes 25. In this manner, the spindle 1 may be mounted in first and second positions to third and fourth mower decks respectively having a different mounting hole pattern than that of the first and second mower decks.

While specific embodiments of the invention have been described and illustrated, it is to be understood that these embodiments are provided by way of example only and that the invention is not to be construed as being limited thereto, but only by proper scope of the following claims.

It is now claimed:

1. A vegetation mower, comprising:
a frame;
at least two ground engaging wheels operatively attached to said frame for use in providing mobility to said mower;
an engine operatively attached to said frame;
a first mower deck operatively attached to said frame;
a spindle adapted to be mounted to said first mower deck, said spindle also adapted to be mounted to a second associated mower deck, wherein said second associated mower deck is substantially different than said first mower deck;
power transferring means for use in transferring power from said engine to said spindle.

2. The mower of claim 1, wherein said spindle comprises:
a body having an outer surface; and,
a flange extended from said outer surface, said flange including a first set of holes for use in fastening said spindle to said first mower deck, said flange also including at least a second set of holes for use in fastening said spindle to said second associated mower deck.

3. The mower of claim 2, wherein said a first set of holes is disposed on a first path, said first path having a first radius,
wherein said at least a second set of holes is disposed on a second path, said second path having a second radius, and,
wherein said first radius is substantially smaller than said second radius.

4. The mower of claim 1, wherein said spindle is adapted to be mounted to said first mower deck in a first position,
wherein said spindle is also adapted to be invertibly mounted to said second associated mower deck in a second position.

5. The mower of claim 4, wherein said spindle comprises:
a body including an inner region;
a shaft having first and second ends, said shaft operatively received into said inner region;
a first shield operatively received by said shaft at said first end; and,
a second shield operatively received by said shaft at said second end.

6. The mower of claim 5, wherein said body has an outer surface and first and second ends, said spindle further comprising;
a flange extended radially outward from said outer surface of said body, said flange disposed longitudinally from said first end at a distance D1, and from said second end at a distance D2; and,
wherein said distance D1 is substantially shorter than said distance D2.

7. The mower of claim 6, wherein said flange includes a first set of holes disposed on a first path, said first path having a first radius, said first set of holes for use in fastening said spindle to one of said first and associated second mower decks.

8. The mower of claim 7, wherein said flange includes at least a second set of holes disposed on a second path, said second path having a second radius, said at least a second set of holes for use in fastening said spindle to at least a third associated mower deck, and,
wherein said first radius is substantially smaller than said second radius.

9. A spindle, comprising:
a body having an inner region and an outer surface;
a shaft having first and second ends, said shaft operatively received by said body into said inner region;
a flange extended radially outward from said outer surface for use in operatively mounting said spindle to a first associated implement; and,
wherein said spindle is adapted for invertibly mounting to a second associated implement.

10. The spindle of claim 9, further comprising:
a shield received by said shaft at a first end; and,
a second shield received by said shaft at a second end.

11. The spindle of claim 10, wherein said body has first and second ends, and wherein said flange is disposed a distance D1 from said first end of said body and a distance D2 from said second end of said body, wherein said distance D1 is substantially shorter than said distance D2.

12. The spindle of claim 11, wherein said flange includes a first set of holes for use in mounting said spindle to one of said first and second associated implements and further comprising:
a second set of holes for use in mounting said spindle to at least a third associated implement.

13. The spindle of claim 9, wherein said first associated implement is a first associated mower deck, wherein said second associated implement is a second associated mower deck, and, wherein said at least a third associated implement is at least a third associated mower deck.

14. The spindle of claim 13, wherein said spindle is adapted to be mounted to said first mower deck in a first position, and is also adapted to be mounted to said second mower deck in a second position, and,
wherein said spindle is adapted to be mounted to said third mower deck in a first position, and is also adapted to be mounted to a fourth mower deck in said second position.
